(19) United States
(12) Patent Application Publication
(10) Pub. No.: US 2006/0133419 A1
(43) Pub. Date: Jun. 22, 2006

(54) Indication of an error in receive offload packets

(76) Inventors: John Ronciak, Beaverton, OR (US); Christopher Leech, Portland, OR (US); Pratulla Deuskar, Hillsboro, OR (US); Jesse Brandeburg, Portland, OR (US); Patrick Connor, Portland, OR (US)

Correspondence Address: Grossman, Tucker, Perreault & Pfleger, PLLC;c/o PortfolioIP, P.O. Box 52050, Minneapolis, MN, 55402, US

(21) Appl. No.: 11/020,963

(22) Filed: Dec. 22, 2004

(51) Int. Cl. H04J 3/14; H04J 1/16; H04L 1/00; H04J 3/22; H04J 3/16; H04J 3/24

(52) U.S. Cl. 370/469; 370/474

(57) ABSTRACT

A receive segmentation offload method according to one embodiment for operating a network controller coupled to a host networked device running a protocol stack. The method may include the network controller receiving an inbound packet, the network controller detecting an error in the inbound packet, and the network controller notifying the protocol stack of the error. Of course, many alternatives, variations, and modifications are possible without departing from this embodiment.

### FIELD

This disclosure relates to indication of an error in receive offload packets.

### BACKGROUND

A variety of devices such as personal computers (PCs), printers, servers, handheld computing devices, and other devices may exchange data and/or commands with each other over an associated network utilizing a variety of communication protocols. Such devices may each have a network controller to provide a network connection between the device and the associated network.

A host processor of the device and the network controller may together facilitate bidirectional communication between the devices via the network. However, especially as network speeds have increased over the years, the host processor may prove to be a communication bottleneck given a conventional distribution of labor between the host processor and the network controller. To remove this bottleneck and free the host processor up to perform other tasks, network controllers have been developed to offload some of the functionality normally provided by the host processor during both transmit and receive functions.

During receipt of a packet from a sending device, a conventional receive segmentation offload method performed by a network controller may analyze the received data portion of the packet to determine if there are any errors in the received packet. If there is an error, the entire packet (header and data portion) and/or flow of entire packets may be discarded. Therefore, no response signal indicating either a successful or unsuccessful receipt of the packet(s) may be sent back to the sending device. In this instance, the sending device may wait a certain time interval. When the time interval expires without the receipt of a signal indicating a successful receipt of the packet(s), the sending device may assume there was an error and re-transmit the affected packet(s). Since the sending device necessarily waits for this time interval to expire (sometimes referred to as a timeout condition) before re-sending the affected packet(s), a drawback of this conventional receive segmentation offload method is that it may result in excessive time delays when there are errors in the received data.

### BRIEF DESCRIPTION OF THE DRAWINGS

Features and advantages of embodiments of the claimed subject matter will become apparent as the following Detailed Description proceeds, and upon reference to the Drawings, where like numerals depict like parts, and in which:

FIG. 1 is a diagram illustrating a system embodiment;

FIG. 2 is a diagram illustrating in greater detail one embodiment of a networked device of the system of FIG. 1;

FIG. 3 is a diagram illustrating treatment of packets with and without errors by a network controller and a networked device; and

FIG. 4 is a flow chart illustrating operations according to an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

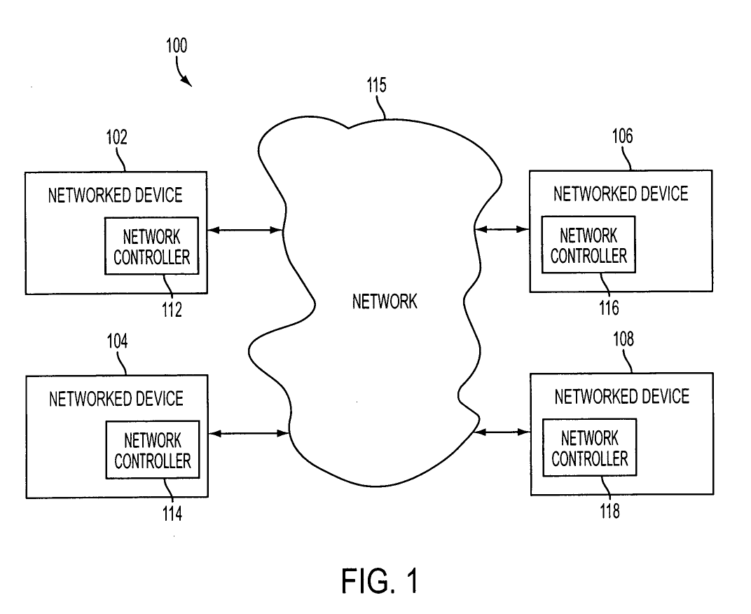

FIG. 1 illustrates a system 100 consistent with an embodiment. The system 100 may include a plurality of networked devices 102, 104, 106, 108 that may exchange data and/or commands with each other via a network 115. The networked devices 102, 104, 106, 108 may include, but not be limited to, a variety of devices such as a personal computers (PCs), laptop computers, printers, servers, handheld computing devices, and storage devices.

Each networked device 102, 104, 106, 108 may have an associated network controller 112, 114, 116, 118 to facilitate bidirectional communication between networked devices 102, 104, 106, 108 via the network 115. Communication over the network 115 may comply or be compatible with a variety of communication protocols. One such communication protocol may comply or be compatible with an Ethernet protocol. The Ethernet protocol may comply or be compatible with the Ethernet standard published by the Institute of Electrical and Electronics Engineers (IEEE) titled the IEEE 802.3 standard, published in March 2002 and/or later versions of this standard. Another communication protocol may be Transmission Control Protocol/Internet Protocol (TCP/IP) that may comply or be compatible with the Transmission Control Protocol Specification published by the Information Sciences Institute, dated 1981, and the Internet Protocol Specification also published by the Information Sciences Institute, dated 1981 and/or later versions of these Specifications.

Data and/or commands exchanged between networked devices 102, 104, 106, 108 may be parsed into packets for efficient routing. As used herein, a “packet” may comprise one or more symbols and/or values. The size, type, and attributes of such packets may be defined, at least in part, by the particular communication protocol being utilized. The network 115 may be any variety or combination of networks such as local area networks (LANs) and wide area networks (WANS) such that any plurality of networked devices may communicate with each other.

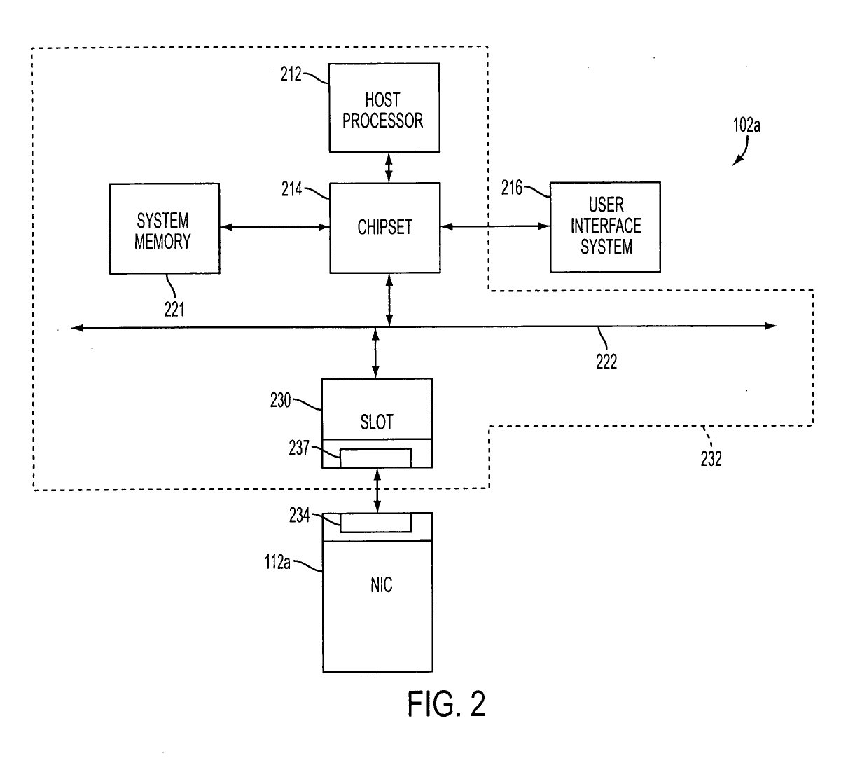

FIG. 2 is a block diagram of one embodiment 102a of the networked device 102 of the system of FIG. 1. The networked device 102a may include a host processor 212, a bus 222, a user interface system 216, a chipset 214, system memory 221, and a network interface card 112a. The host processor 212 may include one or more processors known in the art such as an Intel® Pentium® IV processor commercially available from the Assignee of the subject application. The bus 222 may include various bus types to transfer data and commands. For instance, the bus 222 may comply with the Peripheral Component Interconnect (PCI) Express™ Base Specification Revision 1.0, published Jul. 22, 2002, available from the PCI Special Interest Group, Portland, Oreg., U.S.A. (hereinafter referred to as a “PCI Express™ bus”). The bus 222 may alternatively comply with the PCI-X Specification Rev. 1.0a, Jul. 24, 2000, available from the aforesaid PCI Special Interest Group, Portland, Oreg., U.S.A. (hereinafter referred to as a “PCI-X bus”).

The user interface system 216 may include one or more devices for a human user to input commands and/or data and/or to monitor the system, such as, for example, a keyboard, pointing device, and/or video display. The chipset 214 may include a host bridge/hub system (not shown) that couples the processor 212, system memory 221, and user interface system 216 to each other and to the bus 222. The chipset 214 may include one or more integrated circuit chips, such as those selected from integrated circuit chipsets commercially available from the Assignee of the subject application (e.g., graphics memory and I/O controller hub chipsets), although other integrated circuit chips may also, or alternatively be used.

The network controller 112 may enable bidirectional communication between the networked device 102a and other networked devices coupled to the network 115. In one embodiment, the network controller 112 of FIG. 1 may be implemented as a network interface “card” (NIC) 112a as detailed in FIG. 2. When the NIC 112a is properly inserted into the slot 230, connectors 234 and 237 may become electrically and mechanically coupled to each other. When connectors 234 and 237 are so coupled to each other, the NIC 112a may be electrically coupled to the bus 222 and may exchange data and/or commands with system memory 221, host processor 212, and/or user interface system 216 via the bus 222 and chipset 214. Alternatively, the network controller 112 may be included in other structures, systems, and/or devices. These other structures, systems, and/or devices may also be for example, in the motherboard 232 and coupled to the bus 222. These other structures, systems, and/or devices may also be, for example, comprised in chipset 214. The NIC 112a may comprise a hardware component and a software driver running on the host networked device to facilitate bi-directional communication between the networked device 102a and other networked devices.

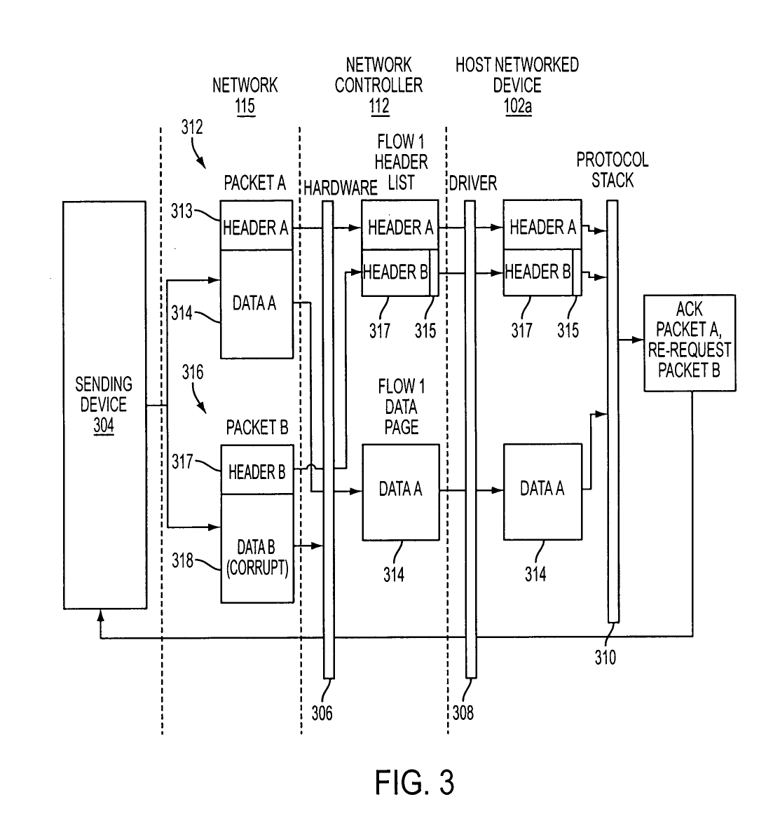

FIG. 3 is a block diagram illustrating portions of the network controller 112, e.g., the NIC 112a in one embodiment, and the host networked device 102a that may receive inbound packets (packets A 312 and B 316) sent by a sending device 304. The network controller 112 may include hardware 306 to perform functions that may be offloaded from the host networked device 102a and processor 212. A driver 308 may be a software program running on the host networked device 102a to interface the network controller 112 with the protocol stack 310 and the operating system and other applications of the host device. The protocol stack 310 may be a software stack running on the host networked device 102a. The protocol stack 310 may utilize any variety of communication protocols and in one embodiment may be a Transmission Control Protocol/Internet protocol (TCP/IP) stack. The protocol stack 310 may perform control decisions for the host networked device while offloading other functions, e.g. error checking of received data, to the hardware 306 of the network controller 112.

The sending device 304 may be any variety of devices such as one of the networked devices 102, 104, 106, 108 of FIG. 1. Packets A 312 and B 316 may be received by hardware 308 of the network controller 112. Each packet 312 and 316 may have a header and data portion. The type of information included in the header portion and the amount of data in the data portion depends, at least in part, on the particular communication protocol being utilized. In general, the header portion may include a command that indicates the start of the packet, source address information, destination address information, and an error checking code.

The hardware 306 of the network controller 112 may perform a variety of checks on the inbound packets to detect an error in any of the inbound packets. The error may be any type of error anywhere in the inbound packet. An incomplete flow may also be indicative of an error. In one embodiment, the hardware 306 may check for an error in the data portion of an inbound packet by computing an error detection code associated with the data portion of the inbound packet and comparing it with a pre-computed value included in the inbound packet by the sending device. If the results do not match, the hardware 306 may determine there is an error in the data portion of the inbound packet. Alternatively, if the results do match, the hardware 306 may determine there is no error in the data portion of the inbound packet.

In the illustrated embodiment of FIG. 3, the hardware 306 of the network controller 112 may detect an error in inbound packet B 316 but no error in inbound packet A 312. The hardware 306 of the network controller 112 may then notify the protocol stack 310 of the error in packet B. One way to notify the protocol stack 310 is to modify an existing flag in the header 317 or append a new flag 315 to the header 317 of packet B. In these instances, the hardware 306 of the network controller may also transfer the header with such a flag to the driver 308 running on the host device 102a. The driver 308 may then further transfer the header 316 with such a flag to the protocol stack 310 also running on the host device. If the error occurred in the data portion 318 of packet B 316, the hardware 306 may also discard the data portion 318. Another way to notify the protocol stack 310 of the error in packet B is to transfer an out-of-band signal to the stack 310 representative of the error.

In response to notification of an error in an inbound packet, the protocol stack 310 may transmit a response signal back to the sending device 304. The response signal may indicate to the sending device 304 that there was an error in inbound packet B. The response signal may also indicate to the sending device to re-send packet B. The response signal may also acknowledge successful receipt of packet A 312 without any errors.

The functionality of the network controller 112 described above as being provided by hardware 306, may alternatively be performed by software and/or firmware. To assist in this regard, machine-readable program instructions for the network controller 112 may be stored in any variety of machine-readable media so that when the instructions are executed by a machine it may result in the machine performing operations described herein. The machine readable media may be comprised in the network controller 112 or in other locals accessible by the machine. The machine may be a processor comprised in the network controller 112 or alternatively an integrated circuit capable of executing the stored instructions. As used herein, an “integrated circuit” or IC means a semiconductor device and/or microelectronic device, such as, for example, a semiconductor integrated circuit chip.

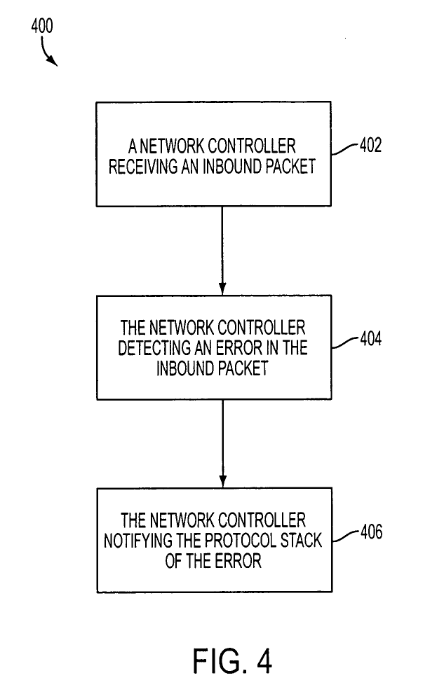

FIG. 4 is a flow chart 400 of operations consistent with an embodiment. Operation 402 may include a network controller receiving an inbound packet. Operation 404 may include the network controller detecting an error in the inbound packet. Finally, operation 406 may include the network controller notifying the protocol stack of the error. For example, FIG. 3 illustrates the network controller 112 detecting an error in inbound packet B. The network controller 112 may then notify the protocol stack 310 of the error. This may then enable the protocol stack to intelligently and quickly respond to such a condition, e.g., by sending a response signal back to the sending device requesting the sending device re-send packet B in this instance.

It will be appreciated that the functionality described for all the embodiments described herein, may be implemented using hardware, firmware, software, or a combination thereof.

Thus, in summary, one embodiment may comprise an apparatus. The apparatus may comprise a network controller that is capable of being coupled to a host computer running a protocol stack. The network controller may further be capable of receiving an inbound packet. The network controller may further be capable of detecting an error in the inbound packet. The network controller may further be capable of notifying the protocol stack of the error.

Another embodiment may comprise an article. The article may comprise a machine readable medium having stored thereon instructions that when executed by a machine results in the following: detecting an error in an inbound packet received at a network controller coupled to a host networked device running a protocol stack; and notifying the protocol stack of the error.

Yet another embodiment may include a system. The system may comprise a networked device comprising a network interface card capable of being coupled to a bus. The networked device may run a protocol stack. The network interface card may further be capable of receiving an inbound packet. The network interface card may further be capable of detecting an error in the inbound packet. Finally, the network interface card may further be capable of notifying the protocol stack of the error.

Advantageously, in these embodiments an error in an inbound packet may be detected by the network controller and the protocol stack running on a host networked device may be quickly notified of the error. Therefore, the protocol stack can respond to the sending device with a response signal to inform the sending device of the error. The response signal may also request the sending device to re-send the affected packet or packets. Therefore, the sending device advantageously does not have to wait for a timeout condition to re-send the packet or packets. Accordingly, the time delays associated with the conventional receive segmentation offload method having errors in received data are shortened.

The terms and expressions, which have been employed herein, are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. A receive segmentation offload method for operating a network controller coupled to a host networked device running a protocol stack, said method comprising:
said network controller receiving an inbound packet;
said network controller detecting an error in said inbound packet; and
said network controller notifying said protocol stack of said error.

2. The method of claim 1, further comprising said protocol stack transmitting a signal to a sending device of said inbound packet representative of said error in said inbound packet in response to said network controller notifying said protocol stack of said error.

3. The method of claim 2, wherein said signal comprises data representative of a request to said sending device to re-send said inbound packet.

4. The method of claim 1, wherein said inbound packet has a header and data portion and wherein said error occurs in said data portion.

5. The method of claim 4, further comprising said network controller discarding said data portion of said inbound packet in response to detecting said error in said data portion.

6. The method of claim 4, further comprising detecting said error in said data portion by computing an error detection code associated with said data portion of said inbound packet and comparing said error detection code with a pre-computed value included in said inbound packet by a sending device.

7. An apparatus comprising:
a network controller that is capable of being coupled to a host networked device running a protocol stack, said network controller further being capable of receiving an inbound packet, said network controller further being capable of detecting an error in said inbound packet, and said network controller further being capable of notifying said protocol stack of said error.

8. The apparatus of claim 7, wherein said protocol stack is capable of transmitting a signal to a sending device of said inbound packet representative of said error in said inbound packet in response to said network controller notifying said protocol stack of said error.

9. The apparatus of claim 8, wherein said signal comprises data representative of a request to said sending device to re-send said inbound packet.

10. The apparatus of claim 7, wherein said inbound packet has a header and data portion and wherein said error occurs in said data portion.

11. The apparatus of claim 10, wherein said network controller is also capable of discarding said data portion of said inbound packet in response to detecting said error in said data portion.

12. The apparatus of claim 10, wherein said network controller is capable of detecting said error in said data portion by computing an error detection code associated with said data portion of said inbound packet and comparing said error detection code with a pre-computed value included in said inbound packet by a sending device.

13. An article comprising:
a machine readable medium having stored thereon instructions that when executed by a machine results in the following:
detecting an error in an inbound packet received at a network controller coupled to a host networked device running a protocol stack; and
notifying said protocol stack of said error.

14. The article of claim 13, wherein said inbound packet has a header and data portion and wherein said error occurs in said data portion.

15. The article of claim 14, wherein said instructions that when executed by said machine also result in discarding said data portion of said inbound packet in response to detecting said error in said data portion.

16. The article of claim 14, wherein said detecting operation detects said error by computing an error detection code associated with said data portion of said inbound packet and comparing said error detection code with a pre-computed value included in said inbound packet by a sending device.

17. A system comprising:
a networked device comprising a network interface card capable of being coupled to a bus, said networked device running a protocol stack, said network interface card further being capable of receiving an inbound packet, said network interface card further being capable of detecting an error in said inbound packet, and said network interface card further being capable of notifying said protocol stack of said error.

18. The system of claim 17, wherein said protocol stack is capable of transmitting a signal to a sending device of said inbound packet representative of said error in said inbound packet.

19. The system of claim 17, wherein said inbound packet has a header and data portion and wherein said error occurs in said data portion.

20. The system of claim 19, wherein said network interface card is also capable of discarding said data portion of said inbound packet in response to detecting said error in said data portion.
